(19) United States
(12) Patent Application Publication
(10) Pub. No.: US 2025/0015657 A1
(43) Pub. Date: Jan. 9, 2025

(54) ROTOR FOR AN ELECTRIC MOTOR WITH STATOR COOLING

(71) Applicant: Dr. Ing. h.c. F. Porsche Aktiengesellschaft, Stuttgart (DE)

(72) Inventor: Stefan KUMMER, Bietigheim-Bissingen (DE)

(21) Appl. No.: 18/757,507

(22) Filed: Jun. 28, 2024

(30) Foreign Application Priority Data
Jul. 4, 2023 (DE) 10 2023 117 610.2

(51) Int. Cl. H02K 1/32; H02K 1/24

(52) U.S. Cl. CPC H02K 1/32; H02K 1/24

(57) ABSTRACT

An internal rotor for an electric motor, which is designed to rotate in a stator due to a magnetic field generated in the stator to drive a rotor shaft arranged on a rotor axis, the internal rotor including a rotor body having rotor teeth, rotor windings which are arranged on the rotor teeth, a displacement body is arranged in a circumferential direction of the rotor between adjacent rotor teeth. The at least one displacement body includes a cooling channel configured to enable transport of a coolant between a first reinforcement ring including a coolant inlet and a second reinforcement ring including a coolant outlet. The first reinforcement ring and the second reinforcement ring are arranged in an axial direction on opposite end faces of the rotor. The coolant outlet is configured such that the escaping coolant experiences a movement via a component in a radial direction of the rotor.

### CROSS REFERENCE TO RELATED APPLICATIONS

This application claims benefit to German Patent Application No. DE 10 2023 117 610.2, filed on Jul. 4, 2023, which is hereby incorporated by reference herein.

### FIELD

The invention relates to a rotor for an electric motor, in particular for a separately excited synchronous machine with stator cooling, in particular for use in a motor vehicle.

### BACKGROUND

Electric motors exist in a variety of different versions. In this context, the use of separately excited synchronous machines comprising internal rotors is widespread, particularly in vehicles. In contrast to permanently excited synchronous machines, the magnetic field generated in the rotor is produced by electric motors and, unlike permanently excited synchronous machines in which permanent magnets are used to create the magnetic field, is therefore controllable. In internal rotors, the rotor rotates in a stator designed as a hollow cylinder, whereas in electric motors comprising an external rotor (referred to as an outer armature), the rotor rotates as a hollow cylinder around a stator. Regarding the present disclosure, a rotor is considered an inner armature of an electric machine.

Due to the current in both the rotor windings and the stator windings of the electric motor, and the prevailing electrical resistance in that location, as well as the constantly changing magnetic field, the operation of an electric machine generates heat, which negatively affects both the performance of the electric motor, and consequently its consumption, and the longevity of the electric motor. Preferably, both the stator and the rotor therefore have to be cooled.

For this purpose, a coolant, in particular a cooling oil, is used, which is directed through both the stator and the rotor and absorbs the heat generated in that location. The coolant can also be distributed to the windings in order to cool them as well. To be able to provide the volume flow of coolant, the use of a pump is required. It is in this case desirable to minimize the pumping capacity as much as possible in order to minimize losses in the overall system and achieve maximum overall efficiency of the electric motor.

To reduce the pumping capacity, systems are known from the prior art in which the coolant used to operate the rotor is distributed onto the stator after leaving the rotor in order to achieve a cooling effect there as well. Patent document DE 10 2022 209 821 A1 discloses an electric machine comprising a rotor and a stator, in which the rotor comprises a plurality of cooling channels, each comprising a coolant outlet on both end faces, whereby a balancing element is arranged on each end face which deflects the coolant escaping from the coolant in the direction of the stator in such a way that the coolant flows onto the stator windings of the stator.

An electric machine comprising a rotor and a stator is known from document DE 10 2010 047 507 A1, in which the rotor comprises such a coolant deflecting element on each end face which deflects the coolant flowing onto the end faces and cooling the rotor in the direction of the stator windings to cool the stator.

Document DE 10 2019 122 944 A1 discloses a rotor for an electric machine, whereby the rotor comprises an end disk at each end which is designed such that a coolant circulates around the end disks.

DE 10 2019 113 159 A1 furthermore discloses a spray cooling system for a stator of an electric machine in which nozzles are provided on a housing of the electric machine to spray the stator windings with coolant.

### SUMMARY

In an embodiment, the present disclosure provides an internal rotor for an electric motor, which is designed to rotate in a stator due to a magnetic field generated in the stator in order to drive a rotor shaft arranged on a rotor axis, the internal rotor comprising a rotor body comprising a plurality of rotor teeth, rotor windings which are arranged on the rotor teeth, and at least one displacement body, which is arranged in a circumferential direction of the rotor between two adjacent rotor teeth. The at least one displacement body comprises a cooling channel, which is configured to enable transport of a coolant between a first reinforcement ring comprising a coolant inlet and a second reinforcement ring comprising at least one coolant outlet. The first reinforcement ring and the second reinforcement ring are arranged in an axial direction on opposite end faces of the rotor. The at least one coolant outlet is arranged and configured such that the escaping coolant experiences a movement via a component in a radial direction of the rotor.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a first embodiment of the electric motor 1 according to the present disclosure;

FIG. 2 shows a perspective view of a second star disk 15b according to an electric motor 1 according to an embodiment of the invention;

FIG. 3a shows a perspective view of a second reinforcement ring 14b according to an electric motor 1 according to an embodiment of the invention;

FIG. 3b shows a detailed illustration in cross-section of the embodiment of the second reinforcement ring 14b shown in FIG. 3a;

FIG. 3c shows a detailed illustration in plan view onto the embodiment of the second reinforcement ring 14b shown in FIG. 3a; and

FIG. 4 shows a schematic illustration of a second embodiment of the electric motor 1 according to the present disclosure.

### DETAILED DESCRIPTION

In an embodiment, the present invention provides a rotor for an electric motor, in which the cooling capacity of the rotor coolant is further improved and the overall efficiency of the electric motor can be improved.

The internal rotor according to an embodiment of the invention of an electric motor is designed to rotate within a stator due to a magnetic field generated in the stator in order to drive a rotor shaft arranged on a rotor axis. In this case, the rotor axis is the axis of rotation of the rotor, and thus also of the shaft. In the context of the present disclosure, it is also referred to as a longitudinal axis or axial axis. The term “axial direction” therefore refers to a direction that extends parallel to the axis of rotation of the electric motor. On the other hand, the term “radial direction” refers to an axis that is perpendicular to the axis of rotation. The “circumferential direction” describes the direction that extends in a circular path around the axis of rotation.

The rotor according to an embodiment of the invention comprises a rotor body comprising a plurality of rotor teeth and is preferably formed from a laminated core, i.e., from a large number of individual laminations which extend in the plane perpendicular to the axis of rotation and are stacked in the axial direction of the rotor. Rotor windings are arranged on the rotor teeth. Also provided is at least one displacement body, which is arranged in the circumferential direction of the rotor between two adjacent rotor teeth and comprises a cooling channel, which is designed to enable transport of a coolant between a first reinforcement ring comprising a coolant inlet and a second reinforcement ring comprising a preferably round coolant outlet, whereby the first reinforcement ring and the second reinforcement ring are arranged on in an axial direction opposite end faces of the rotor. The reinforcement rings therefore enclose the rotor body in an axial direction on both end faces. The at least one coolant outlet is arranged and designed such that the escaping coolant experiences a movement via a component in the radial direction of the rotor.

As a result of the centrifugal force acting on the coolant when the rotor rotates, the coolant is distributed outward in radial direction, and thus distributed onto the stator surrounding the rotor and the windings thereof. Consequently, the cooling capacity of the stator cooling can be decreased and the pumping capacity of the respective coolant pump can be reduced. The losses of the overall system can therefore be reduced.

In an advantageous embodiment of the invention, at least one coolant outlet is arranged radially on the circumference of the second reinforcement ring, and therefore on the lateral surface of the rotor. It is in this way possible to easily distribute the coolant in radial direction through the coolant outlet designed in said manner. The acceleration of the coolant in radial direction due to the centrifugal force also creates a suction effect that pulls the coolant toward the coolant outlet, as a result of which the pumping capacity of the coolant pump of the rotor, which is preferably also the pump of the stator, can be reduced. Such a solution is moreover structurally simple to design because no additional components are required.

Also advantageous is a rotor according to an embodiment of the invention in which a coolant outlet is arranged on a distribution collar, which is arranged in an axial direction on the second reinforcement ring. In this context, the distribution collar is understood as a component that is either designed to be integral, i.e. in one piece, with the second reinforcement ring or is at least fixedly attached to it as a separate component and also axially creates a space between the coolant outlet and the rotor. The axial spacing ensures that the coolant does not enter the air gap between the rotor and the stator, because this would reduce the efficiency of the electric motor. The distribution collar can in this case be understood as a component that is continuous in circumferential direction with coolant outlets distributed at least partly over the circumference, or as individual elevations from the reinforcement ring in an axial direction, whereby at least one coolant outlet is provided in the projections.

In an advantageous embodiment of the invention, the at least one coolant outlet is designed to allow the coolant to escape at a first angle to the radial direction of the rotor, so that movement of the escaping coolant comprises a component in an axial direction. A coolant conduit is preferably provided for this purpose, which leads to the coolant outlet at the first angle to the radial direction of the rotor. In this case, the coolant conduit can, e.g., be designed as a straight channel, or also as a curved channel that conducts the coolant to the coolant outlet. Taking into account the first angle ensures that the coolant is directed in an axial direction away from the air gap between the rotor and the stator. The risk of coolant entering the air gap and reducing the efficiency of the electric machine (electric motor) can therefore be minimized.

An embodiment of the rotor according to the invention is also advantageously provided in which the at least one coolant outlet is designed to allow the coolant to escape at a second angle to the radial direction in the circumferential direction of the rotor. The coolant is therefore not discharged from the rotor in radial direction, but is shifted by an angle in circumferential direction. As a result, better guidance of the coolant is enabled, which improves the cooling capacity of the coolant flowing out of the rotor and thus enhances the positive effect achieved by embodiments of the invention.

In an advantageous embodiment of the invention, the second reinforcement ring comprises a coolant intake which is designed to collect the coolant flowing out of the displacement body and distribute it to the coolant outlet, preferably via at least one coolant conduit. The coolant intake enables even distribution of the coolant to especially provided multiple coolant conduits, which then lead to at least one coolant outlet. As a result, better cooling capacity is achieved.

The rotor preferably further comprises a first star disk and a second star disk, which are arranged in an axial direction between the rotor body and the first reinforcement ring or the second reinforcement ring, and the second star disk comprises a coolant conduit which is designed to direct coolant escaping in an axial direction from cooling channels provided in the rotor body to at least one intermediate opening in the second star disk, and whereby the intermediate opening is further designed to direct the coolant radially to least one coolant outlet provided in the second reinforcement ring. A coolant outlet of a reinforcement ring of the rotor according to an embodiment of the invention is always designed such that the escaping coolant experiences a movement via a component in the radial direction of the rotor. The coolant flowing through the rotor core can in this way be used to cool the stator in addition to the coolant that flows through the displacement body. As a result, the cooling capacity at the stator provided by the rotor is increased, which makes it possible to further reduce the pumping capacity of the coolant pump and enhance the advantageous effect of embodiments of the invention.

Such an embodiment of the invention is particularly advantageous if a coolant intake designed to receive the coolant from the rotor core and direct it to the at least one intermediate opening is arranged in the second star disk as well. Providing a coolant intake enables a uniform distribution of the coolant to especially provided multiple coolant conduits, which then lead in a distributed manner to at least one coolant outlet. As a result, it is possible to achieve a better cooling capacity.

The at least one intermediate opening is preferably designed to allow the coolant to escape at a first angle to the radial direction of the rotor, so that the movement of the escaping coolant comprises a component in an axial direction, and/or allow to it to escape at a second angle to the radial direction in the circumferential direction of the rotor. Taking into account the first angle ensures that the coolant is directed in an axial direction away from the air gap between the rotor and the stator. Coolant can therefore be prevented from entering the air gap and reducing the efficiency of the electric machine (electric motor). Using a second angle enables better guidance and distribution of the coolant, which improves the cooling capacity of the coolant flowing out of the rotor, and thus enhances the positive effect achieved by embodiments of the invention. Such an embodiment also enables distribution of the coolant to a plurality of coolant outlets.

Preferably, multiple coolant outlets are provided for each coolant intake in order to enable a desirable even distribution over the circumference of the rotor.

Advantageous embodiments and aspects of the invention are hereafter described in more detail with reference to the accompanying drawings.

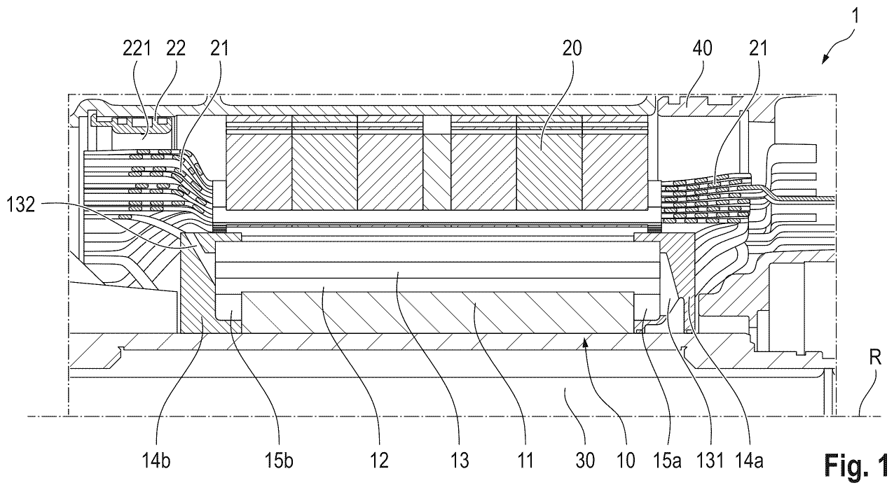

FIG. 1 shows a schematic illustration of a first embodiment of the electric motor 1 according to the present disclosure in a cross-section. For the sake of clarity, only half of the electric motor 1 is shown in this case. A drawn axis of rotation R is in this context understood to mean an axis of symmetry. The electric motor 1 comprises a rotor 10, which is arranged on a rotor shaft 30 opposite to a stator 20. The rotor 10 in this case rotates due to the magnetic field generated in the rotor 10 and the stator 20 and transmits the rotation to the rotor shaft 30, which consequently rotates about the axis of rotation R. An air gap is provided between rotor 10 and the stator 20. The arrangement is located inside a housing 40. The windings 21 needed to create the magnetic field of the stator 20 are also shown schematically. A spray ring 22, which surrounds the windings 21 in circumferential direction and distributes coolant via spray ring openings 221 onto the windings 21 for cooling, is arranged on the housing 40 as well.

The rotor 10 comprises a rotor core 11, which consists of a laminated core of individual laminations. Said rotor comprises a plurality of rotor teeth, on which windings are arranged. Displacement bodies, which each comprise a cooling channel 13 that passes axially through the respective displacement body 12 from one end face to the other, are provided in the circumferential direction of the rotor 10 between the windings around the individual rotor teeth. Reinforcement rings 14a, 14b are provided on both end faces of the rotor 10, whereby a coolant inlet 131 is arranged in the first reinforcement ring 14a, via which coolant enters the cooling channel 13 of the displacement body 12, and a coolant outlet 132 is arranged in the second reinforcement ring 14b, via which coolant can escape from the cooling channel 13. A first star disk 15a and a second star disk 15b are respectively arranged between the reinforcement rings 14a, 14b.

The coolant outlet 132 is arranged such that the coolant carried in the cooling channel 13 of the displacement body 12 is directed in radial direction onto the stator 20, more specifically onto the stator windings 21. The windings 21 are consequently cooled by the coolant of the rotor 10. As a result of this cooling effect, the pumping capacity of the coolant pump to provide coolant through the spray ring 22 can be reduced, thus saving energy. Consequently, the overall efficiency of the electric motor 1 can be improved.

Given the correspondingly designed and arranged coolant outlet 132, the movement of the outflowing coolant in this case includes a component in the radial direction. The centrifugal force acting on the coolant during the rotation of the rotor 10 in this case accelerates the coolant, so that a suction effect is created at the coolant outlet 132 which draws in the coolant in the cooling channel 13 and therefore contributes to the transport of the coolant.

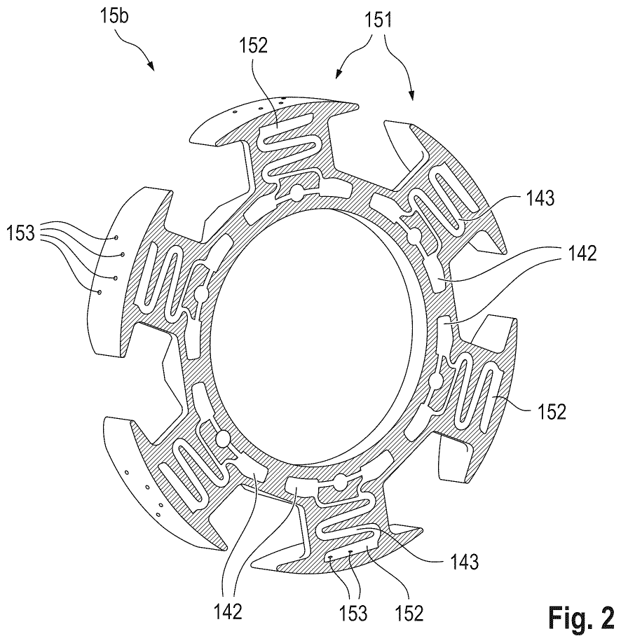

FIG. 2 shows a perspective view of a second star disk 15b according to an electric motor 1 according to an embodiment of the invention, whereby the star disk 15b shown in this case is used in the embodiment according to FIG. 1. The star disk 15b is in this case designed as a high disk comprising individual teeth 151. These correspond to the rotor teeth of the rotor 10. The cross-section of the second star disk 15b corresponds to the cross-section of the rotor body 11. The rotor windings of the individual rotor teeth are respectively wound around the teeth 151, so that two different windings are adjacent in circumferential direction between two teeth 151. The displacement body 12 shown in FIG. 1 extends between these rotor windings.

The second star disk 15b also comprises a plurality of coolant intakes 142 distributed in circumferential direction, which are connected to distribution elements 152 via coolant conduits 143 that extend in a meandering manner in the teeth 151. These distribution elements 152 in turn are fluidically connected to individual intermediate openings 153. The coolant intakes 142 are provided for receiving coolant which flows through the rotor core to cool it. The coolant is collected there and discharged from the star disk 15b via the coolant conduits 143 and the intermediate openings 153.

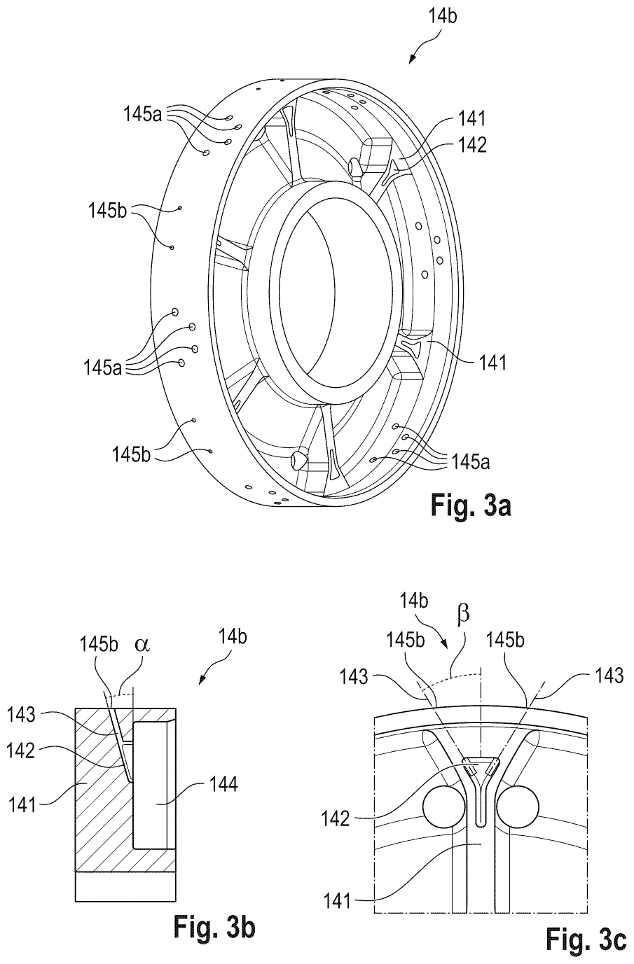

The second star disk 15b is in this case provided in a second reinforcement ring 14b, which is shown in FIG. 3a. The second star disk 15b is in this case oriented in the second reinforcement ring 14b such that the intermediate openings 153 are located exactly above first openings 145a of the second reinforcement ring 14b. This disk also comprises bar elements 141, in which coolant intakes 142 are formed. The bar elements 141 are in this case arranged between the teeth 151 of the second star disk 15b and form the extension of the displacement body 12 provided in the rotor 10. The cooling channel 13 in each displacement body 12 opens into one of the coolant intakes 142. From there, the coolant passes through coolant conduits 143 to second openings 145b, which, like the first openings 145a, are distributed radially in circumferential direction on the reinforcement ring 14b, i.e. on its lateral surface.

Therefore, both the coolant flowing through the displacement body 12 and the coolant flowing through the rotor core 11 can be received by the second reinforcement ring 14b and discharged from the rotor 10 in at least a partially radial direction and directed onto the stator 20 surrounding the rotor 10. In the exemplary embodiment shown, the coolant outlet 132 is realized by a plurality of first openings 145a and second openings 145b.

FIG. 3b shows a detailed illustration in cross-section of the embodiment of the second reinforcement ring 14b shown in FIG. 3a. This detail view shows only a bar element 141 comprising a coolant intake 142. A displacement body receptacle 144, into which the displacement body 12 (see FIG. 1) is inserted, is also provided. Two coolant conduits 143, indicated by dashed lines, extend from the coolant intake 142 to the second openings 145b. The coolant conduits 143 do not in this case extend outward exactly in radial direction, but rather in an axial direction at a first angle α to the radial direction.

Consequently, the coolant does not only flow out in radial direction, but also in an axial direction, whereby the coolant is in this case discharged away from the rotor core, and therefore also away from the air gap between the rotor and the stator. As a result, it is possible to reduce the likelihood of coolant entering the air gap, and thus affecting the efficiency of the electric machine.

FIG. 3c shows a detailed illustration in plan view onto the embodiment of the second reinforcement ring 14b shown in FIG. 3a. This detail view shows only one bar element 141 comprising a coolant intake 142. Two coolant conduits 143 (indicated by dashed lines) extend from the coolant intake 142 to the second openings 145b. The coolant conduits 143 do not in this case extend outward exactly in radial direction, but rather in circumferential direction at a second angle β to the radial direction. As a result, two coolant outlets 132 in the form of second openings 145b are provided for each coolant intake 142. Such an embodiment makes it possible to optimize the distribution of coolant in the circumferential direction.

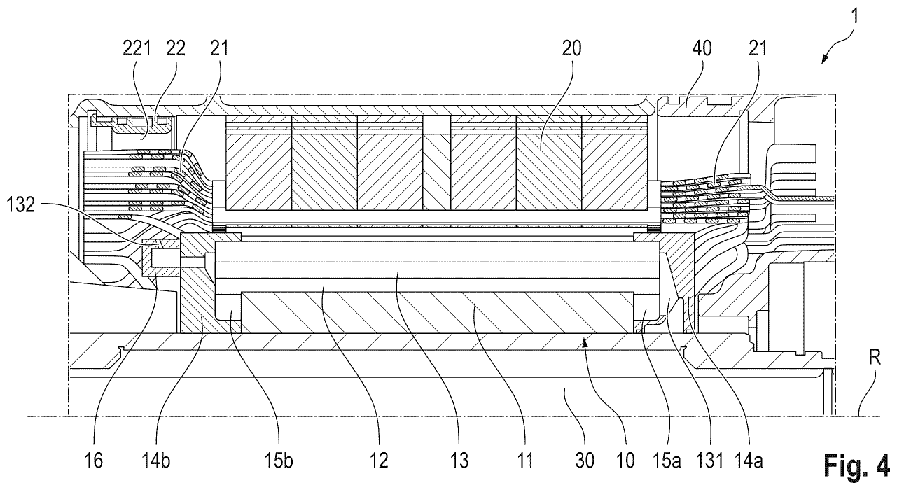

FIG. 4 shows a schematic illustration of a second embodiment of the electric motor 1 according to the present disclosure. The second embodiment substantially corresponds to the first embodiment shown in FIG. 1, for which reason only the differences will be discussed herein.

Unlike the first embodiment, the second embodiment comprises a distribution collar 16. The latter extends from the second reinforcement ring 14b away from the rotor 10 in an axial direction, so that the coolant outlet 132 is at a distance from the rotor 10. Consequently, the risk of coolant entering the air gap between the rotor 10 and the stator 20, and thus impairing the efficiency of the electric machine can similarly be reduced.

In the embodiment shown in FIG. 2, the coolant conduit 143 in this case initially extends in an axial direction through the second reinforcement ring 14b and extends in radial direction only in the distribution collar 16. The distribution collar 16 can in this case be provided as a continuous ring, which extends on the second reinforcement ring 14b or is formed by individual elements projecting from the second reinforcement ring 14b. The second reinforcement ring 14b can likewise be designed as a single component with the distribution collar 16, or a two-part design can be provided, in which the distribution collar 16 is fixedly connected to the second reinforcement ring 14b.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Electric motor
10 Rotor
11 Rotor body
12 Displacement body
13 Cooling channel
131 Coolant inlet
132 Coolant outlet
14a First reinforcement ring
14b Second reinforcement ring
141 Bar element
142 Coolant intake
143 Coolant conduit
144 Displacement body receptacle
145a First opening
145b Second opening
15a First star disk
15b Second star disk
151 Tooth
152 Distribution element
153 Intermediate opening
16 Distribution collar
20 Stator
21 Stator winding
22 Spray ring
221 Spray ring opening
30 Rotor shaft
40 Housing
R Axis of rotation

1. An internal rotor for an electric motor, which is designed to rotate in a stator due to a magnetic field generated in the stator in order to drive a rotor shaft arranged on a rotor axis, the internal rotor comprising:
a rotor body comprising a plurality of rotor teeth;
rotor windings which are arranged on the rotor teeth; and
at least one displacement body, which is arranged in a circumferential direction of the rotor between two adjacent rotor teeth and comprises a cooling channel, which is configured to enable transport of a coolant between a first reinforcement ring comprising a coolant inlet and a second reinforcement ring comprising at least one coolant outlet, wherein the first reinforcement ring and the second reinforcement ring are arranged in an axial direction on opposite end faces of the rotor, and
the at least one coolant outlet is arranged and configured such that the escaping coolant experiences a movement via a component in a radial direction of the rotor.

2. The rotor according to claim 1, wherein at least one coolant outlet is formed radially on a circumference of the second reinforcement ring.

3. The rotor according to claim 1, wherein at least one coolant outlet is arranged on a distribution collar which is arranged in an axial direction on the second reinforcement ring.

4. The rotor according to claim 1, wherein the at least one coolant outlet is configured to allow the coolant to escape at a first angle to the radial direction of the rotor, so that movement of the escaping coolant comprises a component in an axial direction.

5. The rotor according to claim 4, wherein a coolant conduit is provided, which leads to the coolant outlet at the first angle to the radial direction of the rotor.

6. The rotor according to claim 1, wherein the at least one coolant outlet is configured to allow the coolant to escape at a second angle to the radial direction in the circumferential direction of the rotor.

7. The rotor according to claim 1, wherein the second reinforcement ring comprises a coolant intake, which is configured to collect the coolant flowing out of the displacement body and distribute it to the coolant outlet via at least one coolant conduit.

8. The rotor according to claim 1, wherein the rotor further comprises a first star disk and a second star disk, which are arranged in an axial direction between the rotor body and the first reinforcement ring and the second reinforcement ring, and the second star disk comprises a coolant conduit, which is configured to direct coolant escaping in an axial direction from cooling channels provided in the rotor body to at least one intermediate opening in the second star disk, and wherein the at least one intermediate opening is further configured to direct the coolant radially to least one coolant outlet provided in the second reinforcement ring.

9. The rotor according to claim 8, wherein a coolant intake, which is configured to receive the coolant from the rotor core and direct it to the at least one intermediate opening, is also arranged in the second star disk.

10. The rotor according to claim 8, wherein the at least one intermediate opening is configured to allow the coolant to escape at a first angle to the radial direction of the rotor, so that the movement of the escaping coolant comprises a component in an axial direction, and/or allow the coolant to escape at a second angle to the circumferential direction of the rotor.
